(19) United States
(12) Patent Application Publication
(10) Pub. No.: US 2005/0200886 A1
(43) Pub. Date: Sep. 15, 2005

(54) Image data printing method and image data printing apparatus

(75) Inventor: Mitsuru Watanabe, Tokyo (JP)

Correspondence Address: COHEN, PONTANI, LIEBERMAN & PAVANE, 551 FIFTH AVENUE, SUITE 1210, NEW YORK, NY, 10176, US

(73) Assignee: Konica Minolta Opto, Inc., Tokyo (JP)

(21) Appl. No.: 11/070,960

(22) Filed: Mar. 3, 2005

(30) Foreign Application Priority Data
Mar. 11, 2004 (JP) JP2004-069022

(51) Int. Cl. G06F 15/00

(52) U.S. Cl. 358/1.15; 358/448

(57) ABSTRACT

An image data printing method, including: printing an image on a recording medium in accordance with image data using an image forming device; generating encoded data by encoding the image data; and printing the encoded data onto the recording medium using the image forming device.

### BACKGROUND OF THE INVENTION

The present invention relates to image data printing method and image data printing apparatuses, and in particular, to the image data printing method at the time of recording image data by printing images according to the image data on a recording medium using an image forming method and to image data printing apparatus using that method.

Image data photographed using a digital camera can be recorded by printing on paper using an ink jet printer, or a sublimation transfer type printer etc. for home use. Also, the image data photographed using a digital camera can be recorded by printing on photographic photosensitive material such as photographic paper by exposure of light corresponding to the image data.

In this context, it is possible to store image data for long periods without deterioration if it is recorded in the hard disk drives of computers or in various types of optical discs. However, it is also possible that the original image data is lost due to crashing of a hard disk drive or due to damage to or loss of optical disks.

Further, it is difficult to obtain correspondence between the image on the paper on which the image is recorded by printing and the image data within a disk, and it was a time-consuming task to confirm where an image data was stored.

Also, even in recording by printing of photographs using conventional silver halide films, recently it has become common practice to provide the service of storing image data in a CD-R disk at the time of printing the images on photographic paper. However, even in this case there were the problems of the disk being lost or difficulty in obtaining correspondence between the prints and the data in the disk when the number of disks becomes large.

However, when restricted to the correspondence between images recorded on prints and data associated with photographs at the time of photography, methods have been proposed, for example in Patent Document 1 below, of establishing correspondence with images recorded by printing. Patent Document 1: Japanese Unexamined Patent Application Laid-open No. 2003-169276.

In the methods such as the one described in above Patent Document 1, the correspondence was established only between the printed images and the associated data of images such as photograph data. In other words, no method existed for establishing correspondence between the images recorded by printing on paper and its original image data.

Therefore, when it became necessary to enlarge a print in the condition in which the original image data has not been found, merely the image recorded on a print has to be copied, thus causing the problem of the print quality deteriorating. In addition, similar problem was occurring even when the image recorded on a print had to be converted again to electronic data.

Furthermore, the above problems occurred not only for images photographed using a digital camera, but also the problem of establishing correspondence with electronic data, the problem of quality deterioration during copying, and the problems of quality deterioration and wrong recognition at the time of re-digitization existed even for documents printed out using a word processor program of a computer.

### SUMMARY OF THE INVENTION

The present invention was made considering the above problems, and the purpose of the present invention is to realize an image data printing method and image data printing apparatus which solve the problem of establishing correspondence between the images recorded by printing on paper and its original image data, and in which there is no occurrence of deterioration at the time of copying images recorded in a print or at the time of re-converting images recorded in a print into electronic data.

In other words, the above purpose of the present invention is achieved by any one of the Structures (1) to (9) below:

(1) In an image data printing method of recording image data by printing images according to the image data on a recording medium using an image forming apparatus, the image data printing method has the feature that not only the recording by printing is done of images corresponding to the image data using the image forming means on the recording medium, but also encoded data is generated by encoding the image data, and this encoded data is recorded by printing on the recording medium using the image forming means.

(2) The image data printing method according to Structure (1) above with the feature that the recording by printing of the image data and the recording by printing of the encoded data are carried out by recording on different surfaces of the recording medium by printing and the recording of the encoded data by printing is done using recording ink or photosensitive material.

(3) The image data printing method according to Structure (1) above with the feature that the recording by printing of the encoded data is carried out by magnetic recording.

In the present invention, the recording of encoded data by printing on a recorded medium is attempted to be made by magnetic recording.

(4) An image data printing apparatus that records image data by printing images according to the image data on a recording medium, having the feature that the image data printing apparatus comprises an image forming means that records image data by printing images according to the image data on a recording medium, an encoding means for printing that generates encoded data for printing from the image data, and a control means that carries out the controls during printing, wherein the control means carries out controls so as to cause the image forming means to record by printing the image according to the image data and to record by printing the encoded data generated from the image data on the recording means.

(5) The image data printing apparatus according to Structure (4) with the feature that the control means causes the image forming means to carry out the recording by printing of the image data and the recording by printing of the encoded data on different surfaces of the recording medium, and the recording by printing of the encoded data is made to carry out by the use of recording ink or photosensitive material.

(6) The image data printing apparatus according to Structure (4) with the feature that the image forming means is configured so as to be capable of magnetic recording, and the recording by printing of the encoded data is carried out by magnetic recording.

(7) The image data printing method according to Structure (1) or Structure (2) with the feature that the recording by printing of the encoded data is carried out on a separate medium and this separate medium is affixed to the recording medium.

(8) The image data printing apparatus according to Structure (5) or Structure (6) with the feature that the image forming means that carries out recording by printing the encoded data on a separate medium and comprises an affixing means that affixes the separate medium to the recording medium.

(9) The image data printing apparatus according to Structure (5) or Structure (6) with the feature that the image data printing apparatus comprises a second image forming means that carries out recording by printing the encoded data on a separate medium, and an affixing means that affixes the separate medium generated by the second image forming means to the recording medium.

It is possible to obtain the following effects by the present invention according to the above structures.

In Structure (1), at the time of recording the image data according to the image data by printing on the recording medium, not only the recording by printing is done of images corresponding to the image data using the image forming means on the recording medium, but also encoded data is generated by encoding the image data, and this encoded data is recorded by printing on the recording medium using the image forming means.

Here, for the recording of encoded data by printing, it is possible to select a recording method to suit the recording density among several possible methods of recording available in conventional technology such as, a method of recording using 0's and 1's, a method of recording in bar code shape, a method of recording by means of pit positions or pit edges as in optical disks.

Further, here, it is possible to apply the present invention not only when the image data here is data related to images such as photographs, but also when the image data is any data based on characters, ruling lines, figures, or tables constituting a document.

As a result of this, since the image and the encoded original image data are recorded by printing on the same recording medium, the problem of establishing correspondence between the image recorded by printing and the original data and the problem of loss of the original image data will both be solved. In addition, since the encoded original image data is present in the recording medium, there is also no possibility of the image quality getting deteriorated at the time of copying or of re-converting to electronic data the image recorded by printing.

In Structure (2), the recording of encoded data by printing on the recording medium is being done using recording ink or photosensitive materials on a surface (back surface) other than the surface on which the image has been recorded by printing.

Therefore, it is possible to read out optically using a scanner etc. the encoded original image data from the reverse side of the recording medium, the problem of establishing correspondence between the image recorded by printing and the original data and the problem of loss of the original image data will both be solved, and also there is no possibility of the image quality getting deteriorated at the time of copying the image recorded by printing or of re-converting it to electronic data.

In Structure (3), the recording of encoded data by printing on the recording medium is being done by magnetic recording either on the same surface (front surface) as the surface on which the image has been recorded by printing or on a different surface (back surface).

Therefore, it is possible to read out magnetically the encoded original image data from the recording medium, the problem of establishing correspondence between the image recorded by printing and the original data and the problem of loss of the original image data will both be solved, and also there is no possibility of the image quality getting deteriorated at the time of copying the image recorded by printing or of re-converting it to electronic data. Further, since there is no optical effect on the image because of the use of magnetic recording in this manner, it is possible to record not only on the back surface but also on the front surface of the recording medium.

In Structure (7), the recording of encoded data by printing is done on a separate medium and that separate medium is affixed to the recording medium. Therefore, the problem of establishing correspondence between the image recorded by printing and the original data and the problem of loss of the original image data will both be solved, and also there is no possibility of the image quality getting deteriorated at the time of copying the image recorded by printing or of re-converting it to electronic data In addition, since a separate medium on which the encoded data is recorded by printing can be affixed to the recording medium containing the image, the handling becomes easy.

In Structure (8), the recording of encoded data by printing is done on a separate medium and that separate medium is affixed to the recording medium. Therefore, the problem of establishing correspondence between the image recorded by printing and the original data and the problem of loss of the original image data will both be solved, and also there is no possibility of the image quality getting deteriorated at the time of copying the image recorded by printing or of re-converting it to electronic data In addition, since a separate medium on which the encoded data is recorded by printing can be affixed to the recording medium containing the image, the handling becomes easy.

In Structure (9), the recording of encoded data by printing is done on a separate medium by a second image forming means, and that separate medium is affixed to the recording medium. Therefore, the problem of establishing correspondence between the image recorded by printing and the original data and the problem of loss of the original image data will both be solved, and also there is no possibility of the image quality getting deteriorated at the time of copying the image recorded by printing or of re-converting it to electronic data In addition, since a separate medium on which the encoded data is recorded by printing can be affixed to the recording medium containing the image, the handling becomes easy.

### BRIEF DESCRIPTION OF THE DRAWINGS

FIG. 1 is a configuration block diagram showing the electrical configuration of the image data printing apparatus according to a preferred embodiment of the present invention.

FIG. 2 is a flow chart showing the operation of the image data printing apparatus according to a preferred embodiment of the present invention.

FIG. 3 is an explanatory diagram showing the states of the operation example of the image data printing apparatus according to a preferred embodiment of the present invention.

FIG. 4 is a flow chart showing the operation of the image data printing apparatus according to a preferred embodiment of the present invention.

FIG. 5 is a flow chart showing the operation of the image data printing apparatus according to a preferred embodiment of the present invention.

FIG. 6 is a configuration block diagram showing the electrical configuration of the image data printing apparatus according to a preferred embodiment of the present invention.

### DETAILED DESCRIPTION OF THE PREFERRED EMBODIMENT

In the following, the preferred embodiment for implementing the present invention is prescribed in detail referring to figures.

### First Preferred Embodiment

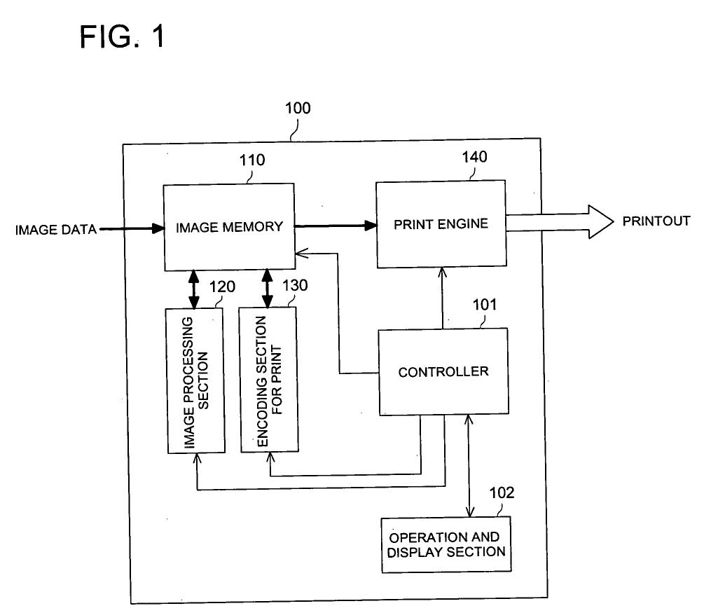

To begin with, a concrete example of the electrical configuration of an image data printing apparatus 100 according to the present preferred embodiment of the invention is explained referring to FIG. 1.

This image data printing apparatus 100 is basically an apparatus normally called an image output apparatus or a printer that carries out recording by printing on recording media such as different types of printing paper or photosensitive materials in accordance with various types of data such as image data or text data (these various types of data are referred to hereinafter as image data) using an image forming means (print engine). Therefore, recording by printing can be done using any method such as recording in the electro-photographic method using toners, ink jet recording that ejects ink, and optical recording on photosensitive materials.

Here, the image data printing apparatus 100 is configured to comprise each of the following means.

Numeral 101 is a control section configured using a CPU etc., as the control means that controls the different sections of the image data printing apparatus 100, and carries out the control of recording by printing in accordance with the image data, the control of generating encoded data, and the control of recording by printing the encoded data etc., as will be described later.

Numeral 102 is an operation and display section configured to comprise an operation means that accepts various types of inputs related to different types of operations or instructions, and a display means that displays various statuses and various messages.

Numeral 110 is an image memory used as the working area memory that temporarily stores the input image data at the time of recording by printing, as the work area memory for carrying out specific image processing on the image data, and also as the working area memory at the time of generating the encoded data.

Numeral 120 is an image processing section that carries out various types of image processing on the image data stored in the image memory 110 necessary at the time of recording by printing.

Numeral 130 is an encoding section for printing that generates the encoded data for recording by printing by encoding the image data stored in the image memory 110.

Numeral 140 is a print engine that functions as an image forming means that carries out recording by printing images or symbols in accordance with image data or encoded data using the methods of ink jet recording or optical recording on recording media such as various types of printing paper or photosensitive materials.

Further, the input of image data to this image data printing apparatus 100 can be made directly from an external equipment such as a computer, or a digital camera, or a memory card, or an image server etc. Such input of input data can also be made using radio waves or infrared rays, or via network.

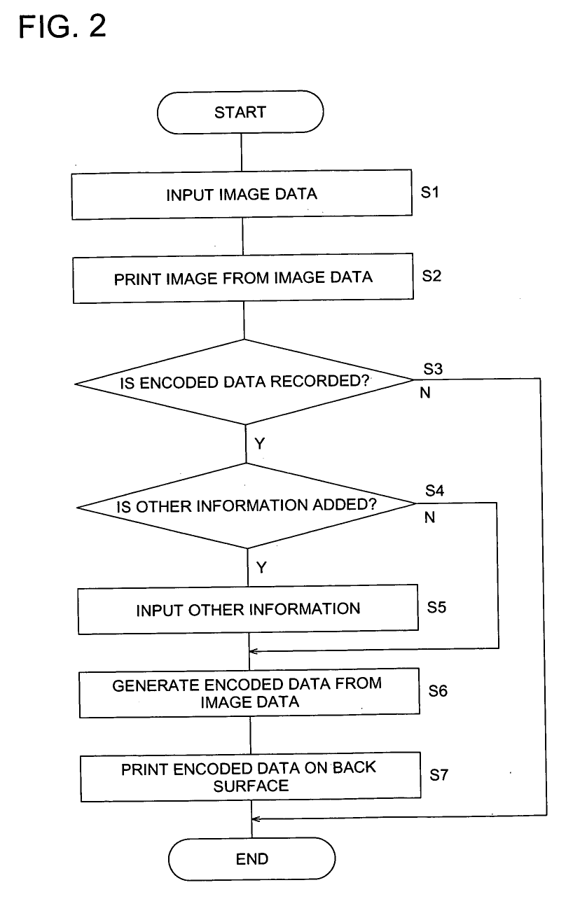

In an image data printing apparatus 100 such as the above, the operation of the sections that are special features of the first preferred embodiment are described below referring to the flow charts in FIG. 2 onwards. Further, in the following description, the control is carried out by CPU 101 unless stated otherwise.

To begin with, image data is input from an external equipment when the image data printing apparatus 100 is in a state in which it can carry out recording by printing (Step S1 in FIG. 2).

The image data input in this manner is temporarily stored in the image memory 110. Next, based on the image data stored in the image memory 110, the print engine 140 records images on the recording media (Step S2 in FIG. 2). However, when the recording medium is printing paper the recording is done by photographic exposure and when the recording medium is ink jet paper the recording is done by ink jet recording.

Here, the control section 101 confirms the setting conditions for the process of recording by printing under execution (Step S3 in FIG. 2), and when the setting is such that the encoded data corresponding to the image data is not to be recorded on the recording medium (‘N’ in Step S3), the operations are terminated with the above step (‘END’ in FIG. 2)

Further, the control section 101 confirms the setting conditions for the process of recording by printing under execution, and when the setting is such that the encoded data corresponding to the image data is to be recorded on the recording medium (‘Y’ in Step S3), it checks whether the setting is such that further separate information is to be included in the encoded data (Step S4 in FIG. 2).

When the setting is such that the encoded data corresponding to the image data is to be recorded on the recording medium (‘Y’ in Step S3) and also the setting is such that further separate information is to be included in the encoded data (‘Y’ in Step S4 of FIG. 2), the control section 101 accepts input of separate information from the console and display section 102 (Step S5 in FIG. 2).

Here, the separate information can be comment statements related to the image data, time-of-day information related to the image data (information of date and time of photograph), location information related to the image data (information of photograph location) etc., and is information whose addition is optional.

Next, the encoding section 130 for printing generates the encoded data based on the instruction from the control section 101 from the image data and the separate data when separate data exists, or from only the image data if no separate data exists (Step S6 in FIG. 2).

The encoded data generated in the encoding section 130 for printing in this manner is temporarily stored in the image memory 110. Next, upon receiving an instruction from the control section 101, based on the image data stored in the image memory 110, the print engine 140 carries out recording by printing the encoded data on the back surface of the recording medium (Step S7 in FIG. 2).

Here, the recording by printing of the encoded data can be done using a recording method to suit the recording density among several possible methods of recording available in conventional technology such as, a method of recording using 0's and 1's, a method of recording in bar code shape, a method of recording by means of pit positions or pit edges as in optical disks. Further, the recording of encoded data by printing on the recording medium can be done using recording ink or photosensitive materials or by magnetic recording.

Further, the following is the possibility of digital recording of encoded data based on the image data. It is possible to record with a minimum pit size of about 10 μm×10 μm taking the resolution of ordinary printers or scanners is around 2400 dots/25.4 mm at the time of making this patent application.

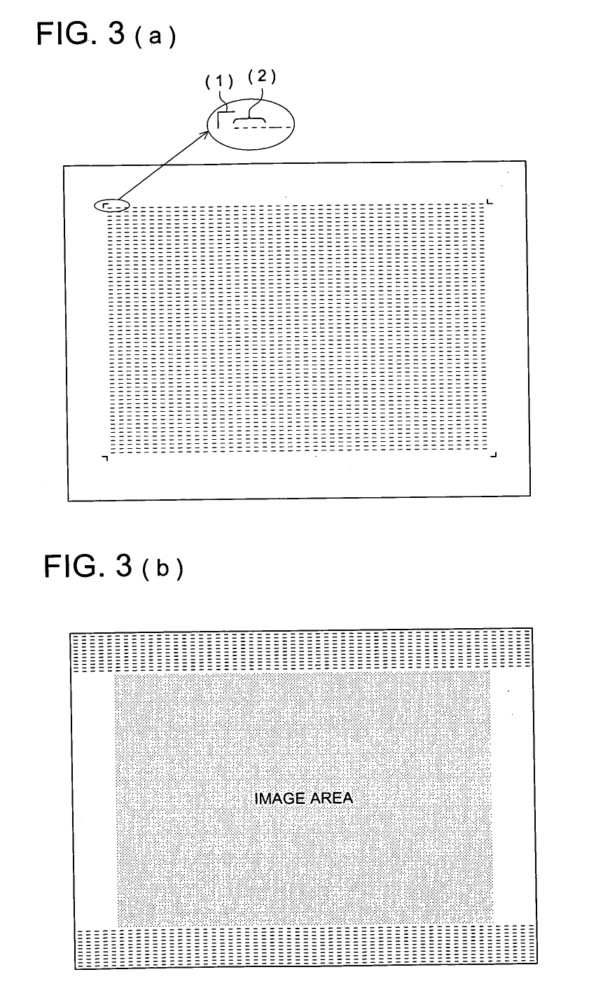

In this case, it is also possible to provide marks indicating the ‘Start’ ((1) of FIG. 3 (a)), or correction pits ((2) of FIG. 3 (a)) for adjusting the magnification of the printer or scanner. Apart from this, it is also possible to provide various types of marks for alignment or end position marks etc. at different locations.

Here, although the recording density depends on the modulation method of recording and the error correction method, if the modulation method of a general storage device (for example, 1-7 modulations), pit edge recording, and error correction methods are used, it is possible to record with a recording density of about 1.5 to 2.0 Kilo bytes/mm².

Since the dimensions of a photograph print of size ‘L’ is 89 mm×127 mm with the area being 11303 mm², even when a peripheral white border part is considered, it is possible to record about 15M bytes of data on the white part at the back of the print. In contrast with this, recording the data of a photograph taken from a 6-Mega pixels digital camera in the RAW data format requires about 7M bytes. Also, about 2M bytes will be sufficient if the storage is done using the commonly used JPEG compression format.

Therefore, because it is possible to record 15M bytes on the white part of the back surface of an “L” size print, it is considered sufficiently possible to record the encoded data based on the image. In other words, it is also possible to use still lower resolution printer or scanner if the encoded data is recorded based on the image data compressed in the JPEG format.

In addition, regarding the images photographed using a digital camera with a large number of pixels, since the prints of the photographs are made on a paper of a size larger than the “L” size, such as the 2L size or cabinet size, and since even the size of the white area on the back surface becomes proportionally larger, it is possible to record encoded data of still larger size photographs even assuming that a still lower resolution printer or scanner is used.

Furthermore, it is also possible to have modified forms of the above by preparing “prints with borders” in which white spaces are left on the borders of the image on the front surface, and encoded data compressing the JPEG format is recorded in that white part of the front surface in addition to the white part on the back surface of the photo print (see FIG. 3(b)).

In addition, the recording of encoded data by printing on the photograph print can be done not only by ink jet recording and optical recording on photosensitive materials but also by carrying out magnetic recording either on the same surface as the one on which the image has been recorded by printing (front surface) or on a different surface (back surface). Further, since there is no optical effect on the image because of the use of magnetic recording in this manner, it is possible to record not only on the back surface but also on the front surface of the recording medium.

Further, in the above case, apart from generating encoded data equivalent to the image data corresponding to the image actually recorded by printing, it is also possible to generate and record by printing the encoded data from the image data of the entire image in the case where the recording by printing is done in the state in which a part of the image has been trimmed.

In addition, in this case, it is necessary to provide from an external equipment the entire image data (an image data including a larger range than the image recorded by printing) and the trimming data for recording the image by printing or else the entire image data can be provided from an external equipment and the trimming information can be provided from the operation and display section 102. Next, in such a case, it is desirable to generate the encoded data from the image data corresponding to the entire image and the trimming information (trimming instructions). By doing so, it also becomes possible to print the entire image later on.

Furthermore, the recording by printing of image data and encoded data as above can be applied not only for images photograph using digital camera but also to texts printed out using word processor program of computer, drawings prepared based on CAD data etc.

Also, the above preferred embodiment of an image forming apparatus that records images by printing based on the image data can also be applied to a 3-dimensional modeling machine that generates 3-dimensional objects based on CAD data. In other words, it is possible to record by printing the encoded data based on the CAD data on a 3-dimensional object prepared based on. CAD data. Because of this, the problem of establishing correspondence between the 3-dimensional object and its CAD data and the problem of loss of the original CAD data can both be solved.

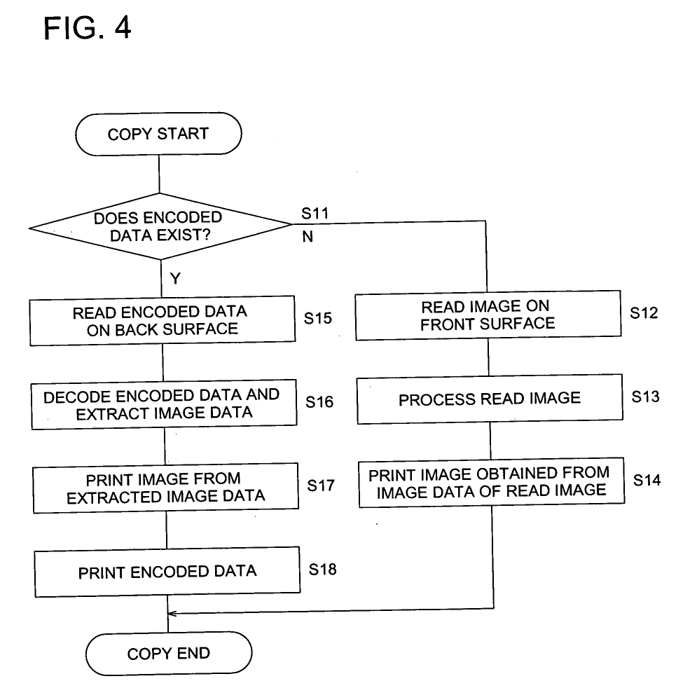

FIG. 4 is a flow chart showing the operation of the image data printing apparatus according to a preferred embodiment of the present invention at the time of copying an image recorded by printing. At the time of carrying out this copying, apart from the image data printing apparatus 100 of FIG. 1, it is necessary to use a scanner (not shown in the figure) as an image reading apparatus, and a computer (not shown in the figure) for processing the encoded data.

To begin with, in the case where no encoded data is present at any position of the recording medium on which recording has been made by printing (‘N’ in Step S11 of FIG. 4), the image on the surface of the recording medium is read as it is by scanning (Step S12 in FIG. 4), image processing such as sharpness correction are made on the read in image (Step S13 in FIG. 4), and the image is recorded by printing (Step S14 in FIG. 4). In this case, since the copying is done by optical means it is unavoidable that some amount of deterioration is present in the image.

In the case where encoded data is present at any position of the recording medium on which recording has been made by printing (‘Y’ in Step S11 of FIG. 4), the encoded data present on the back surface of the recording medium or in the white parts of the front surface of the recording medium, and not the image itself on the front surface of the recording medium, is read in by a scanner (Step S15 in FIG. 4), the read in encoded data is decoded and subjected to necessary processing such as error correction thereby extracting the original image data (Step S16 in FIG. 4). Next, the image is recorded by printing based on the extracted image data (Step S17 in FIG. 4). In addition, the encoded data is recorded by printing at any position of the recording medium (Step S18 in FIG. 4).

In this case, the copying is not done optically but is done digitally based on encoded data and it is possible to carry out recording by printing at least in the same state as the recording by printing of the source image of the copy, and hence it is possible to reproduce the image without any deterioration.

Further, in this case, since the copying is not done optically but is done digitally based on encoded data, even when the copying is to be done with a size larger than the recording by printing of the source of the copy, there is no deterioration in the image during enlargement as in the case of optical copying, and it is possible to carry out recording by printing while maintaining the fineness even after enlargement which is due to the characteristics possessed by the encoded data.

In addition, after several years have passed and the performance of the print engine has been improved compared to that at the time of recording by printing, for example, when the resolution or the color space has been enlarged, by recording again by printing using the encoded data it is possible to obtain a photograph print that is in a superior condition than the original recording by printing.

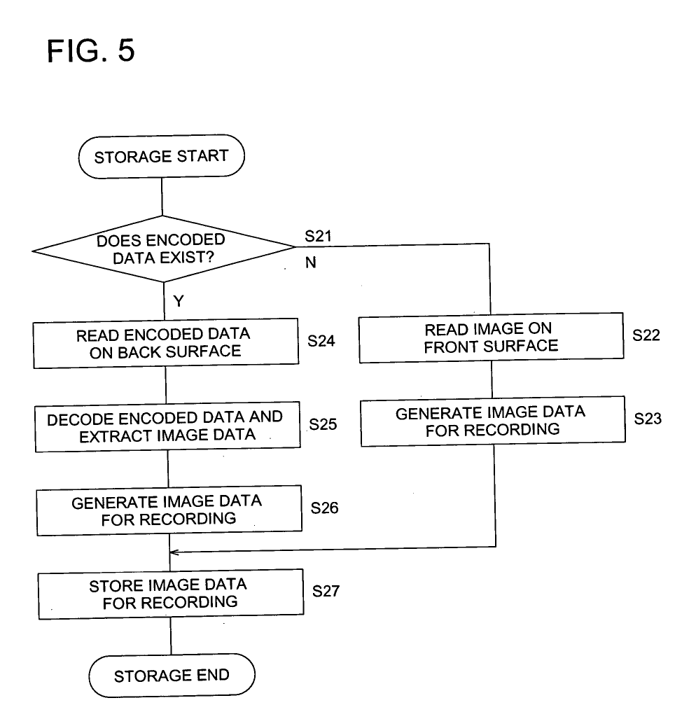

FIG. 5 is a flow chart showing the operation of the image data printing apparatus according to a preferred embodiment of the present invention at the time of storing in the form of electronic data using the storage means the image recorded by printing.

At the time of carrying out this copying, apart from the image data printing apparatus 100 of FIG. 1, it is necessary to use a scanner (not shown in the figure) as an image reading apparatus, a computer (not shown in the figure) for processing the encoded data, and a storage means (such as a hard disk drive, an optical disk drive, a magnetic optical disk, a semiconductor memory, etc.) connected to the computer.

To begin with, in the case where no encoded data is present at any position of the recording medium on which recording has been made by printing (‘N’ in Step S21 of FIG. 5), the image on the surface of the recording medium is read as it is by scanning (Step S22 in FIG. 5), and the image data generated by scanning is sent to the computer. Next, in the computer, image processing such as sharpness correction are made on the read in image when necessary and the image data for recording by printing is generated from the read in image data (Step S23 in FIG. 5).

Next, the image data for recording by printing generated in the above manner is stored in the storage means (Step S27 in FIG. 5). In this case, since the image data for recording by printing is the image data generated by reading out using an optical means it is unavoidable that some amount of deterioration is present in the image.

In the case where encoded data is present at any position of the recording medium on which recording has been made by printing (‘Y’ in Step S21 of FIG. 5), the encoded data present on the back surface of the recording medium or in the white parts of the front surface of the recording medium, and not the image itself on the front surface of the recording medium, is read in by a scanner (Step S24 in FIG. 5), and the image data generated by the scanner (the image data corresponding to the encoded data) is set to the computer. In the computer, the original image data is extracted from the by decoding and carrying out the necessary processing such as error correction (Step S25 in FIG. 5). Next, the image data for recording by printing is generated from the extracted image data (Step S26 in FIG. 5).

The image data for recording by printing generated in the above manner is stored in the storage means (Step S27 in FIG. 5). In this case, since the copying is done not based on image data generated by reading in optically but the image data for recording by printing is being generated based on the image data obtained digitally from the encoded data, there is no deterioration in the image during enlargement as in the case of optical copying, and it is possible to carry out recording by printing while maintaining, the fineness even after enlargement which is due to the characteristics possessed by the encoded data.

### Other Preferred Embodiments

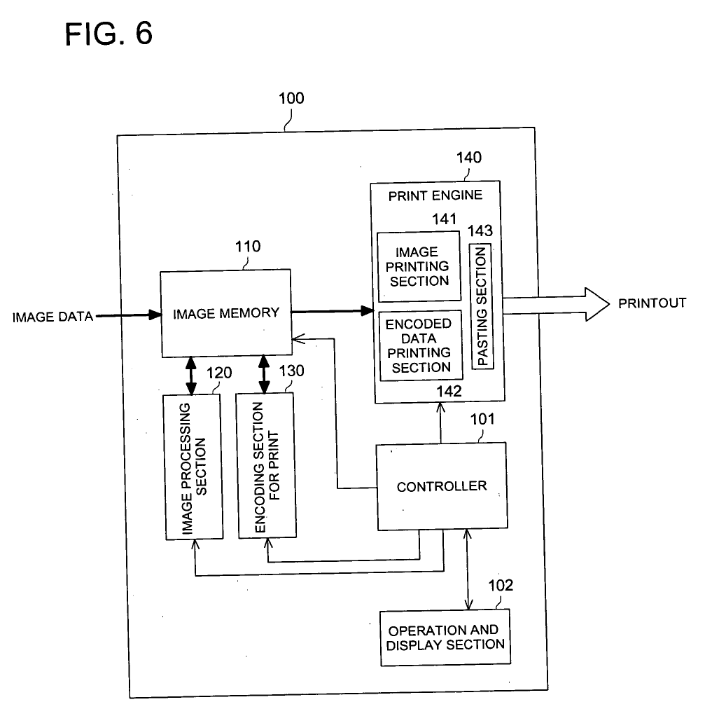

In the description of the above preferred embodiment, the recording by printing of the image and the recording by printing of the encoded data were carried out on the same recording medium by the print engine 140. Apart from this, it is also possible to carry out recording by printing of the encoded data on a separate medium such as a sheet or a seal, and to affix this separate medium on the recording medium. In this case, the recording by printing is carried out on the main recording medium (photographic photosensitive material, printing paper etc.) in the image printing section 141 as is shown in FIG. 6. Also, at the same time, the recording by printing of the encoded data is done on a sheet or seal used as the separate medium in the encoded data printing section 142. Subsequently, the separate medium on which the encoded data has been recorded by printing is affixed to the recording medium on which the image has been recorded by printing in the affixing section 143 and is discharged to outside the apparatus as the print out.

Further, although in this FIG. 6 the image data printing section 141, the encoded data printing section 142 and the affixing section 143 are configured within the print engine 140, it is possible to have a configuration in which these are made as separate and independent units or circuits.

Further, this method of using a separate medium can also be applied to a 3-dimensional modeling machine that generates 3-dimensional objects based on CAD data. In other words, it is possible to affix a sheet or seal on which the encoded data based on the CAD data is recorded by printing on a 3-dimensional object prepared based on CAD data. Because of this, the problem of establishing correspondence between the 3-dimensional object and its CAD data and the problem of loss of the original CAD data can both be solved.

When the amount of encoded data of the image is larger than the maximum data volume which can be recorded, determined by the minimum printing dot size and the printable area, both of which depend on the quality of the printing paper which is the recording medium, it is also possible to record the data after compressing the encoded data of the image to become a data that is smaller in volume than the maximum printable data volume.

1. An image data printing method, comprising:
(a) printing an image on a recording medium in accordance with image data using an image forming device;
(b) generating encoded data by encoding the image data; and
(c) printing the encoded data onto the recording medium using the image forming device.

2. The image data printing method of claim 1, wherein the printing of the image and the encoded data are carried out respectively on surfaces of the recording medium different from each other, and the printing of the encoded data is carried out using recording ink or a photosensitive material.

3. The image data printing method of claim 1, wherein the printing of the encoded data is carried out by a magnetic recording.

4. An image data printing apparatus, comprising:
(a) an image forming device for printing an image in accordance with image data on a recording medium;
(b) an encoding device for generating encoded data for a printing from the image data;
(c) a controller for controlling the image forming device so that the image in accordance with the image data and the encoded data which have been generated from the image data, are printed on the recording medium.

5. The image data printing apparatus of claim 4, wherein the controller causes the image forming device to print the image and the encoded data respectively on surfaces of the recording medium different from each other, and causes the image forming device to print the encoded data using recording ink or a photosensitive material.

6. The image data printing apparatus of claim 4, wherein the image forming device is capable of magnetic recording, and the encoded data is printed by the magnetic recording.

7. The image data printing method of claim 1, wherein the encoded data is printed on an other recording medium different from the recording medium.

8. The image data printing apparatus of claim 5, wherein the image forming device prints the encoded data on an other recording medium different from the recording medium, and further comprises pasting device for pasting the other recording medium to the recording medium.

9. The image data printing apparatus of claim 5, further comprising a second image forming device for printing the encoded data on an other recording medium different from the recording medium, and a pasting device for pasting the other recording medium generated by the second image forming device onto the recording medium.

10. A recording medium on which an image in accordance with image data and encoded data which is generated by encoding the image data, is printed using an image forming device.

11. The recording medium of claim 10, wherein the image in accordance with the image data and the encoded data generated by encoding the image data, are printed on sides different from each other of the recording medium.
